(19) United States
(12) Patent Application Publication
(10) Pub. No.: US 2006/0114218 A1
(43) Pub. Date: Jun. 1, 2006

(54) System and method for flat panel display brightness correction

(75) Inventors: Chia-Pu Ho, Jhonghe City (TW); Chung-Kuang Tsai, Jhudong Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/130,013

(22) Filed: May 16, 2005

(30) Foreign Application Priority Data
Nov. 18, 2004 (TW) 93135383

(51) Int. Cl. G09G 3/36

(52) U.S. Cl. 345/102

(57) ABSTRACT

A system and a method for flat panel display brightness correction, removing brightness difference between flat panel displays in one product line. The brightness correction system comprises a converter for control of color temperature and brightness of an image frame, and a backlight controller for generating corrected light for display in the image frame.

### BACKGROUND

The invention relates to flat panel display, and in particular, to brightness correction for flat panel displays.

FIG. 1 shows a conventional flat panel display architecture. A digital signal 102 is received by a timing controller 104, transformed to an image signal and control signal, and input to line controller 108 and row controller 110, whereby a visual output is displayed on display panel 106 under scan line synchronization control. Timing controller 104 is an Application Specific Integrated Circuit (ASIC) controlling the display panel 106, and the inverter 112 is capable of generating high voltage to drive the backlight module in the display panel 106. The backlight module (not shown) are tubes, LED or plasma cells cooperating with light guides and diffusion films to light the display panel 106. Based on the light provided, and pixel control techniques, color variations of an image can be presented as visual output on display panel 106. The relationship between the input signal and visual output, however, is not linear but exponential, referring to “gamma curve”. Therefore gamma correction is implemented by resistors in the row controller 110 to display the visual output correctly.

Another issue occurs when implementing flat panel displays. Among a plurality of panels within one product line, the physical characteristics are not completely identical, causing brightness not to be uniform when driven in the same condition. The variation is increased after gamma correction, white balance and color temperature compensation. To achieve brightness uniformity, a brightness correction mechanism is desirable. Conventionally, a display panel having the lowest brightness is selected as a reference and brightness of other display panels is reduced according thereto. The display efficiency is derived as follows:
Efficiency=brightness/(voltage*current)

If brightness is reduced by gamma correction, efficiency is decreased, resulting in undesirable power consumption. Therefore an improved method is desirable.

### SUMMARY

An embodiment provides a flat panel display comprising a timing controller, a converter, a memory device, a backlight controller, and a display panel. A digital signal is generated by the timing controller based on a control signal. An image signal is transformed to a corresponding output signal by the converter. A brightness parameter is stored in the memory device. A brightness control signal is generated according to the brightness parameter by the backlight controller. The brightness control signal is received by an inverter to generate a corresponding current. The display panel receives the output signal to generate a visual output, and receives the current to brighten the visual output.

The converter is an arithmetic circuit, providing gamma correction, white balance or color temperature compensation. The memory device is Electrically Erasable Programmable Read-Only Memory (EEPROM) or FLASH ROM. The display panel comprises a column driver and a row driver. The image signal is received from the converter by the column driver to generate the visual output. The row driver receives the control signal to synchronize scan lines.

Another embodiment provides a brightness correction method for flat panel display, comprising the following steps. First, a plurality of flat panel displays is driven based on a selected condition. Brightness of the flat panel displays is then determined. The lowest brightness is chosen therefrom, and corresponding brightness parameters for each flat panel display are calculated accordingly. Flat panel displays controlled by corresponding brightness parameters thus have equal brightness when driven under the same conditions.

The configuration of the selected condition comprises the following steps. First, white balance for each flat panel display is processed, such that the color temperatures thereof are equal. A selected voltage or current is provided to drive the flat panel displays to display full white screens. Brightness determination comprises determining brightness of each full white screen, such that the lowest brightness can be obtained.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 shows a conventional flat panel display architecture;

FIG. 2 shows an embodiment of a flat panel display;

FIG. 3 is a flowchart of brightness correction; and

FIG. 4 shows brightness level of flat panel displays.

### DETAILED DESCRIPTION OF THE INVENTION

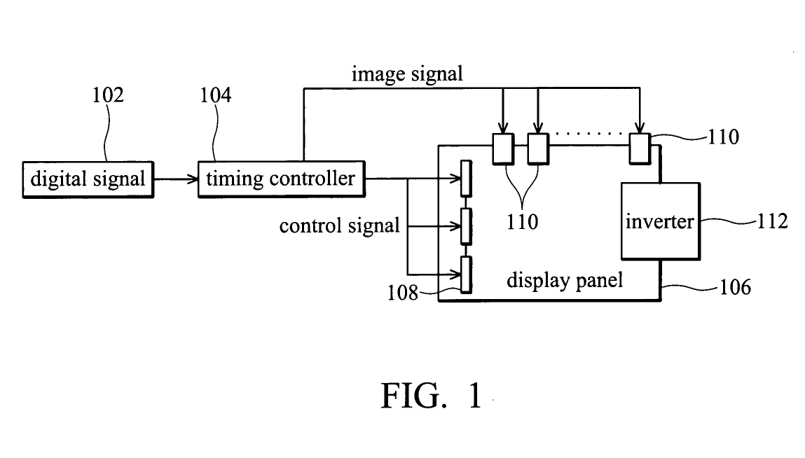

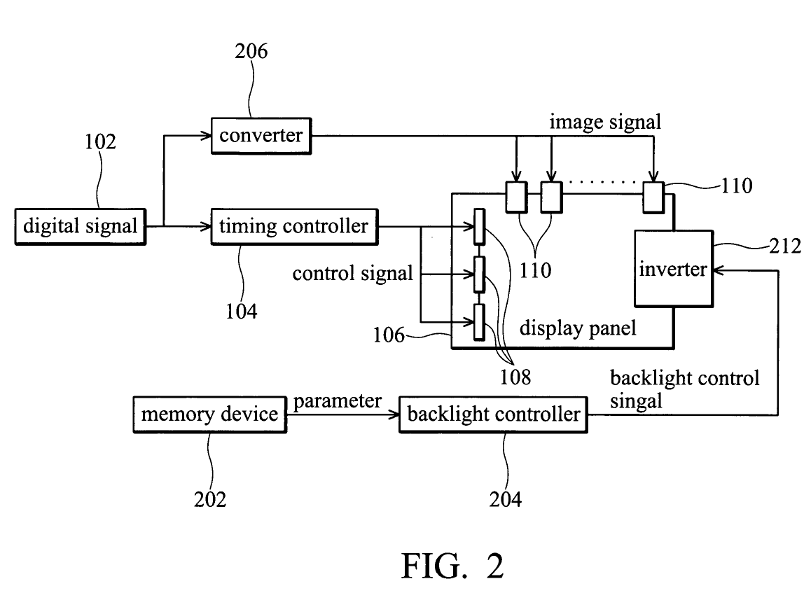

FIG. 2 shows an embodiment of a flat panel display. The timing controller 104, display panel 106, line controller 108 and row controller 110 are identical to the conventional flat panel display in FIG. 1. In addition, a memory device 202, backlight controller 204, converter 206 and inverter 212 are provided. The converter 206 comprises a lookup table (not shown) implemented by an arithmetic circuit or digital component, capable of transforming input values into corresponding output values. After a digital signal 102 is received by the converter 206, the lookup table performs color temperature compensation, white balance and gamma correction for the digital signal 102, and an image signal is then output to the row controller 110. The timing controller 104 receives the digital signal 102 and output a control signal to the line controller 108 for scan line synchronization. A backlight controller 204 is provided for outputting a brightness control signal to the inverter 212 after the brightness parameters in the memory device 202 is read, such that the brightness presented on the display panel 106 is corrected. The inverter 212 is capable of adjusting the output current or output duty cycle according to the brightness control signal, and the brightness of the display panel 106 is tuned accordingly. A pixel map of the visual output is generated by the row controller 110, and the inverter 212 determines the brightness of the visual output. The line controller 108 receives the control signal for scan line synchronization. Based on the architecture, display efficiency remains unaffected because power consumption is proportionally decreased by adjusting the inverter 212.

The inverter 212 can be a Pulse Width Modulation (PWM) inverter, wherein the brightness is proportional to the duty cycle of current. The memory device 202 can be an EEPROM or EFPROM, storing brightness parameters configured in the manufacture stage. The backlight controller 204 and converter 206 can be independent circuit components, or implemented in the timing controller 104. The backlight controller 204 and converter 206, performing gamma correction, white balance and color temperature compensation, are capable of transforming the digital signal 102 to an image signal based on specific lookup tables configured at manufacture stage such as gamma curve, and generating visual output on display panel 106 via row controller 110. The specific lookup tables are stored in memory device 202, thus is flexible to program.

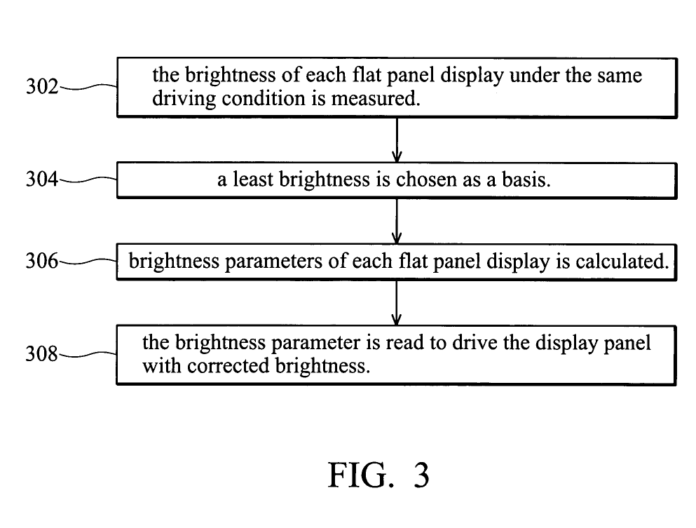

FIG. 3 is a flowchart of brightness correction. Specific driving conditions are defined, and characteristics of all flat panel displays can be measured under the same driving condition. For example, the flat panel displays can receive identical brightness control signals, and identical white balance parameters. In step 302, the brightness of each flat panel display under the same driving condition is measured. In step 304, the lowest brightness is chosen as a reference, and in step 306, brightness parameters of each flat panel display are calculated by comparison with the lowest brightness and then stored in the memory device 202. In step 308, the brightness parameter is read by the backlight controller 204, and a corresponding backlight control signal is generated to control the inverter 212 and generate a current to drive the flat panel display with corrected brightness.

Measurement of brightness under the specific driving conditions comprises the following steps. First, at least one of the following steps is performed on each display panel: gamma correction, white balance and color temperature compensation. Thereafter, the brightness of each display panel is measured.

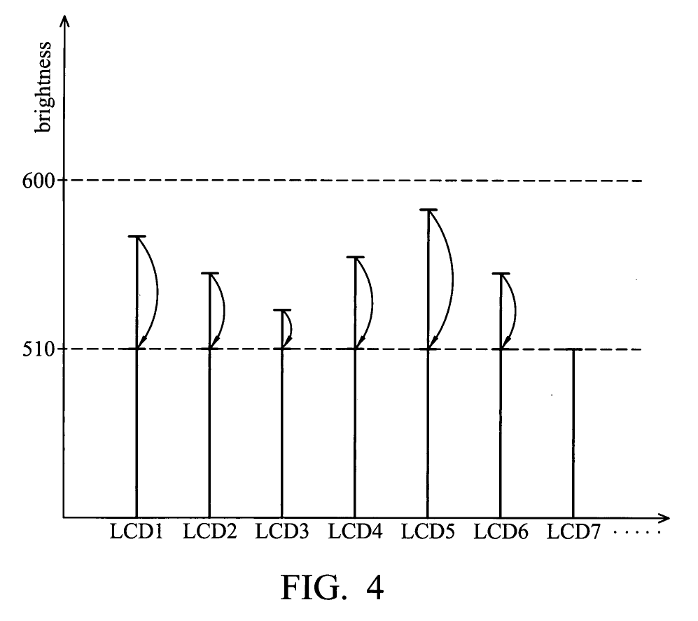

FIG. 4 shows brightness level of a plurality of flat panel displays. Under specific driving conditions, each display panel presents different brightness, and in the embodiment of FIG. 3, the lowest brightness is chosen as a reference, for example, LCD7, whereby all other display panels are reduced accordingly to achieve brightness uniformity among the plurality of flat panel displays.

While the invention has been described by way of example and in terms of the preferred embodiment, it is to be understood that the invention is not limited thereto. Rather, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A flat panel display, comprising:
a timing controller for generating a digital signal based on a control signal;
a converter for transforming an image signal to a corresponding output signal;
a memory device for storing a brightness parameter;
a backlight controller for generating a brightness control signal according to the brightness parameter;
an inverter for receiving the brightness control signal to generate a corresponding current; and
a display panel, adapted to receive the output signal and the corresponding current, for generating a visual output.

2. The flat panel display as claimed in claim 1, wherein the converter comprises an arithmetic circuit.

3. The flat panel display as claimed in claim 1, wherein the converter is configured to provide gamma correction, white balance, or color temperature compensation.

4. The flat panel display as claimed in claim 1, wherein the memory device comprises Electrically Erasable Programmable Read-Only Memory (EEPROM) or FLASH ROM.

5. The flat panel display as claimed in claim 1, wherein the display panel comprises:
a column driver configured to receive the image signal from the converter; and
a row driver configured to receive the control signal to synchronize scan lines.

6. A method for correcting brightness of a plurality of flat panel displays, comprising:
driving the plurality of flat panel displays based on a predetermined condition;
determining brightness of each flat panel display;
identifying the lowest brightness among the brightness determined; and
calculating a set of brightness parameters for each flat panel display according to the lowest brightness;
adjusting the brightness of each flat panel display in accordance with the set of brightness parameters for each flat panel display.

7. The method as claimed in claim 6, further comprising determining the predetermined condition comprising the following steps:
processing white balance for each flat panel display such that the color temperatures thereof are equal; and
providing a selected voltage or current to drive the flat panel displays to display full white screens.

8. The method as claimed in claim 7, wherein determining brightness of each flat panel display further comprises determining brightness of each full white screen.
